(19) United States
(12) Patent Application Publication
(10) Pub. No.: US 2023/0409987 A1
(43) Pub. Date: Dec. 21, 2023

(54) GUIDANCE PROMOTION SERVER, RESERVATION SUPPORT SYSTEM, AND NON-TRANSITORY COMPUTER-READABLE MEDIUM STORING PROGRAM

(71) Applicant: NEC Corporation, Tokyo (JP)

(72) Inventor: Saki Tanaka, Tokyo (JP)

(73) Assignee: NEC Corporation, Tokyo (JP)

(21) Appl. No.: 18/209,292

(22) Filed: Jun. 13, 2023

(30) Foreign Application Priority Data
Jun. 20, 2022 (JP) 2022-099038

(51) Int. Cl. G06Q 10/02; G06Q 30/0251

(52) U.S. Cl. CPC G06Q 10/025; G06Q 30/0255

(57) ABSTRACT

A guidance promotion server includes: a first processing unit that receives a request from a terminal, and transmits the request to a first service reservation server; a second processing unit that temporarily holds a candidate group of a first service being answered by the first service reservation server, based on the request from the terminal, and transmits a part of information constituting the candidate group of the first service to a second service reservation server; and a third processing unit that receives a candidate group answer of a second service from the second service reservation server, based on the information, and transmits, to a user interaction server, a narrowing result from a candidate group of the first service, based on the candidate group answer of the second service, and the candidate group answer of the second service.

### INCORPORATION BY REFERENCE

This application is based upon and claims the benefit of priority from Japanese patent application No. 2022-099038, filed on Jun. 20, 2022, the disclosure of which is incorporated herein in its entirety by reference.

### TECHNICAL FIELD

The present disclosure relates to a guidance promotion server, a reservation support system, and a non-transitory computer-readable medium storing a program.

### BACKGROUND ART

In order to increase convenience of a reservation, a mechanism for promoting a reservation by cooperation with a travel service provider has been considered.

For example, Japanese Unexamined Patent Application Publication No. 2021-33832 describes an integrated reservation support system for supporting a reservation related to a series of itineraries.

When a user desires to receive some sort of integrated service formed of a group of various services, the user needs to reserve various services included in the integrated service. Herein, the user who feels a load of time and effort to make a plurality of reservations may withhold use of the integrated service during reservation work. In other words, a withdrawal risk from the reservation work increases.

In order to solve this, there is a dynamic reservation Web system that can continuously make reservations of a plurality of reservation services. In this case, a search condition for narrowing reservation candidates is input to one certain reservation service, results narrowed by that are indicated on the Web, one is selected from the indicated reservation candidates, and a reservation of a following reservation service proceeds. When reservation information in a prior reservation system is desired to be reconsidered due to a desired time period not being matched and the like during selection of a following reservation service, a path for the reconsideration is constructed, and a reservation can be made again or the reservation information can be corrected according to the path.

### SUMMARY

However, this is merely a configuration for requiring a load of making a reservation again from a user at a time of reconsideration, and there is a problem that a withdrawal risk is still high.

An example object of the invention is to provide a guidance promotion server, a reservation support system, and a program that can reduce a withdrawal risk when reservations of a plurality of reservation services are continuously made.

In a first example aspect, a guidance promotion server includes: at least one memory configured to store a command; and at least one processor configured to execute the command, wherein the at least one processor receives a request from a terminal, and transmits the request to a first service reservation server, temporarily holds a candidate group of a first service answered by the first service reservation server, based on the request from the terminal, and transmits a part of information constituting the candidate group of the first service to a second service reservation server, and receives a candidate group answer of a second service from the second service reservation server, based on the information, and transmits, to a user interaction server, a narrowing result from a candidate group of the first service being narrowed from the temporarily held candidate group answer of the first service, based on the candidate group answer of the second service, and the candidate group answer of the second service.

In a second example aspect, a reservation support system includes: a user interaction server; a guidance promotion server; and a plurality of service reservation servers, wherein a first service reservation server receives a request from a terminal via the user interaction server and the guidance promotion server, the first service reservation server answers a candidate of a first service to the guidance promotion server, the guidance promotion server temporarily holds the candidate group of the first service, and also transmits a part of information constituting the candidate group of the first service to a second service reservation server from the guidance promotion server, a content related to description of a service content is provided from the second service reservation server to the user interaction server, and a candidate group answer of a second service is also transmitted from the second service reservation server to the guidance promotion server, based on the information, the guidance promotion server transmits, to the user interaction server, a narrowing result from a candidate group of the first service being narrowed from the candidate group answer of the first service, based on the candidate group answer of the second service, and the candidate group answer of the second service, and the user interaction server generates an interactive content related to candidate selection by combining the candidate group answer of the first service and the candidate group answer of the second service with a content from the second service reservation server, and transmits the generated content to the terminal.

In a third example aspect, a non-transitory computer-readable medium stores a program causing a computer to execute: a first step of instructing a guidance promotion server to receive a request from a terminal, and transmit the request to a first service reservation server; a second step of instructing the guidance promotion server to temporarily hold a candidate group of a first service answered by the first service reservation server, based on the request from the terminal, and transmit a part of information constituting the candidate group of the first service to a second service reservation server; and a third step of instructing the guidance promotion server to receive a candidate group answer of a second service from the second service reservation server, based on the information, and transmit, to a user interaction server, a narrowing result from a candidate group of the first service being narrowed from the temporarily held candidate group answer of the first service, based on the candidate group answer of the second service, and the candidate group answer of the second service.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration of a guidance promotion server according to a first example embodiment;

FIG. 2 is a diagram illustrating a configuration of a reservation support system according to a second example embodiment;

FIG. 3 is a diagram illustrating a configuration of the reservation support system according to the second example embodiment;

FIG. 4 is a sequence diagram illustrating one example of an operation of the reservation support system according to the second example embodiment; and

FIG. 5 is a block diagram illustrating a configuration of a guidance promotion server according to the second example embodiment.

### EXAMPLE EMBODIMENT

### First Example Embodiment

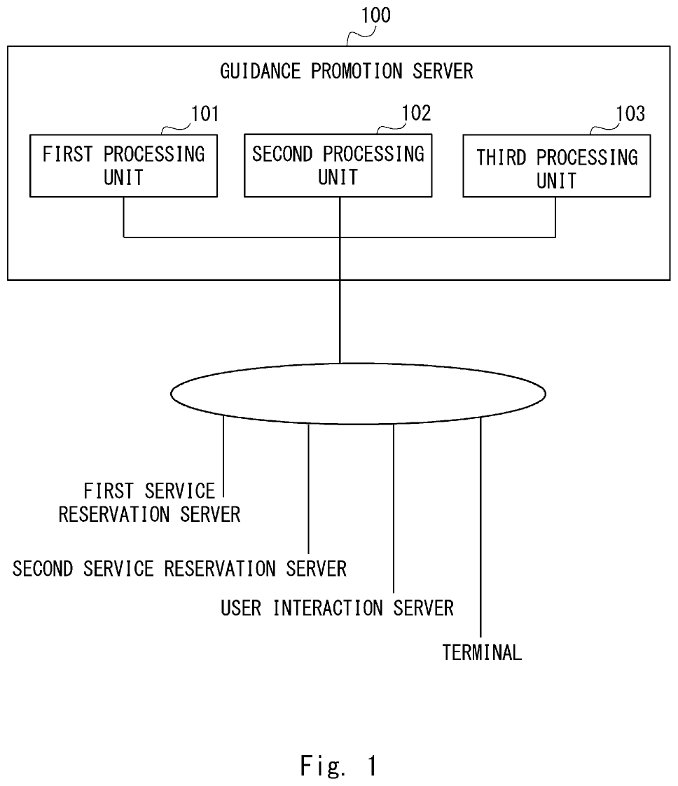

Example embodiments of the present disclosure will be described below with reference to the drawings. FIG. 1 is a block diagram illustrating a configuration of a guidance promotion server according to a first example embodiment. In FIG. 1, a guidance promotion server 100 includes a first processing unit 101, a second processing unit 102, and a third processing unit 103.

The first processing unit 101 receives a request from a terminal, and transmits the request to a first service reservation server.

The second processing unit 102 temporarily holds a candidate group of a first service answered by the first service reservation server, based on the request from the terminal, and transmits a part of information constituting the candidate group of the first service to a second service reservation server. Note that the candidate group of the first service may be one candidate depending on a narrowing condition. Further, temporary holding means at least holding in a period since the first service reservation server answers the candidate group of the first service until a combination of the first service and a second service is confirmed.

The third processing unit 103 receives a candidate group answer of the second service from the second service reservation server, based on the information, and transmits, to a user interaction server, a narrowing result from the candidate group of the first service being narrowed from the temporarily held candidate group answer of the first service, based on the candidate group answer of the second service, and the candidate group answer of the second service.

In this way, the guidance promotion server according to the first example embodiment can reduce a withdrawal risk when reservations of a plurality of reservation services are continuously made.

### Second Example Embodiment

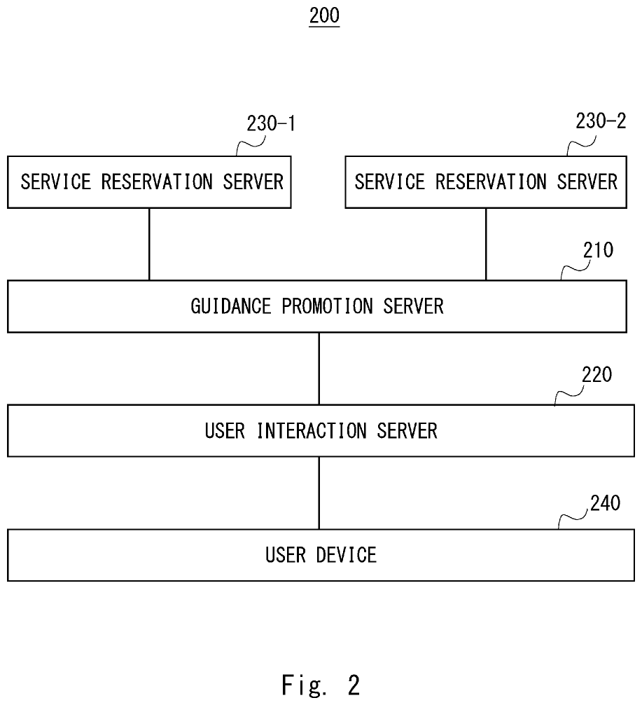

FIG. 2 is a diagram illustrating a configuration of a reservation support system according to the second example embodiment. In FIG. 2, a reservation support system 200 includes a guidance promotion server 100, a user interaction server 220, a service reservation server 230-1, and a service reservation server 230-2.

The guidance promotion server 100 transmits and receives both pieces of information via the user interaction server 220 and a plurality of service provider servers. The guidance promotion server 100 acquires answering information from a terminal 240, transmits the answer to the associated service reservation server 230-1, and also acquires a next interaction clip element (herein exemplified as a video element), based on the answer.

Then, the acquired answering information is used for an inquiry to the other service reservation server 230-2 (following service). Processing of the guidance promotion server 100 is mainly configured to be achieved by cooperation with another server, and thus specific processing will be described below.

The user interaction server 220 is a server that provides a service constituting a viewing environment in the terminal 240. The user interaction server 220 is directly or indirectly connected to an individual reservation server. Then, the user interaction server 220 performs processing of constructing a reproduction environment in such a way that service introduction information (video information) provided from the service reservation servers 230-1 and 230-2 can be reproduced in the terminal 240, and outputting the video information to a device. For example, the user interaction server 220 may include a video provision system. Then, the user interaction server 220 may output the video information as the service introduction information. Further, the video information may be a part of the entire reproduction video, and a part of the information is referred to as a video element herein.

The video element being a source of the video information is directly or indirectly provided from the service reservation server 230-1 or 230-2 being a video provision source, and the user interaction server 220 outputs the video element to the device. Then, the user interaction server 220 directly or indirectly transmits a user answer acquired after the output to the service reservation server 230-1 or 230-2. Herein, indirect transmission/reception indicates a situation where the guidance promotion server 100 is interposed between the user interaction server 220 and the service reservation server 230.

The service reservation servers 230-1 and 230-2 are connected to the guidance promotion server 100. Then, when there is an inquiry request using the answering information acquired from the user interaction server 220 from the guidance promotion server 100, the service reservation server 230-1 transmits the inquiry request to a service candidate DB of the service provider himself/herself. The service candidate DB extracts a service candidate group that can be provided, based on the answering information.

Subsequently, the service reservation servers 230-1 and 230-2 output, to the guidance promotion server 100, the service candidate group being the extraction result based on the inquiry request. Further, when an inquiry request using the answering information of the service reservation server 230-2 different from the service reservation server 230-1 of itself is received from the guidance promotion server 100, any of two kinds of processing below is performed. The inquiry request herein is assumed that, when an extracted service candidate group does not satisfy the answering information of the different service reservation server 230-2, a new candidate group other than a candidate of the extracted service reservation candidate group is indicated for a user by using information on the different service reservation server 230 side, and the like.
1: Furthermore, when extraction of a service candidate group that can be provided is already performed in the service reservation server 230-1 of itself, confirmation processing of one from the extracted service candidate group is also performed based on answering information of the different service reservation server 230-2. The confirmation processing herein means that the service reservation candidate is uniquely confirmed, and, when there are other reservation candidates at the same time, opening up of the reservation candidates may be requested.
2: When a service candidate group that can be provided is not extracted, i.e., in a situation where extraction is assumed to be performed subsequently, the service candidate DB of itself is referred, and related information being associated with information in the service candidate DB is extracted and output to the guidance promotion server 100.

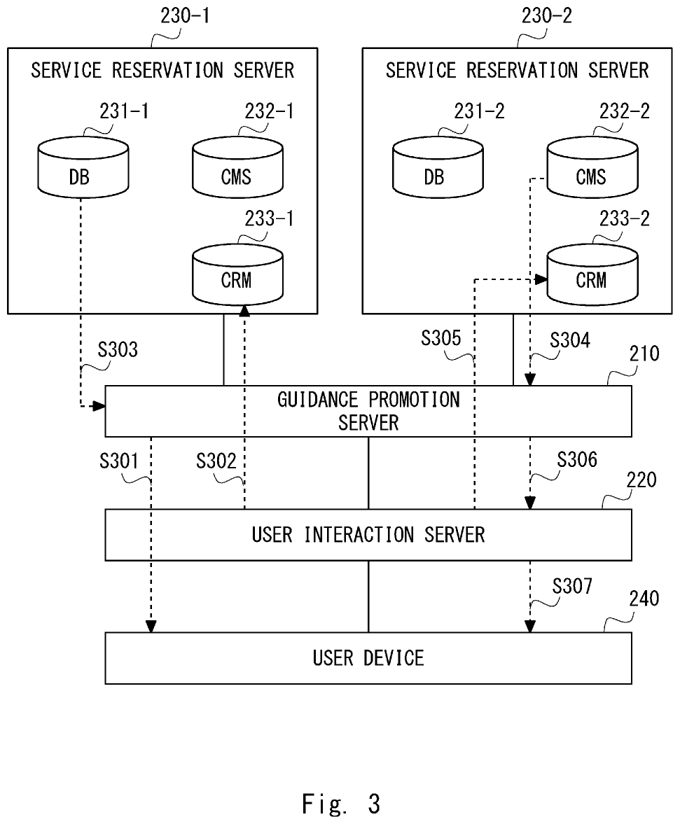

Next, an operation of a reservation support system will be described. FIG. 3 is a diagram illustrating a configuration of the reservation support system according to the second example embodiment.

The service reservation server 230 is managed and operated by each service provider. The service reservation server 230 includes a service database (DB) 231, a service CMS 232, and a service customer relationship management (CRM) 233.

First, a reservation server of a first service (hereinafter referred to as a service reservation server 230-1. A server of a second service is referred to as a service reservation server 230-2) being one service provider system outputs inquiry information to a user device through the interposed user interaction server 220 (S301). A user who receives the inquiry information inputs an answer of the user via a Web browser or an interaction clip during reproduction (for example, an interactive video clip) on the user device. The input may be a sound, or may be selection of an option, an information input, and the like on a touch panel. The inquiry information described herein has an object to acquire an answer of the user via the user device. As long as the object is achieved, the inquiry information may be a video element for making an inquiry, or an input interface such as an input button for prompting a user to select.

The device outputs the acquired user answer to the user interaction server 220 (S302). When the guidance promotion server 100 acquires the user answer via the user interaction server 220, the guidance promotion server 100 transmits the user answer to the service reservation server 230-1 (question source in S301) being one associated service reservation server 230.

The service reservation server 230-1 compares the user answer, acquires an associated reservation candidate group from a service DB 231-1, and outputs the reservation candidate group to the guidance promotion server 100. At this time, the CRM may be used with the reservation candidate group as one piece of information to be extracted. For example, a family structure and a use history so far may be used, and an appropriate reservation candidate group can also be more accurately indicated for a user.

Note that a definition of a function of the CRM is a “tool for collecting and managing customer data and managing a subsequent marketing measure”.

Herein, the guidance promotion server 100 temporarily holds the acquired reservation candidate group and information acquired from the inquiry (S303), and also outputs the acquired user answer to the service reservation server 230-2 that provides a reservation of a following service (S304). Herein, the user answer is needed to acquire advance information about a reservation of the second service, and thus only a part of a user answer output to the first service that does not include personal information or indicates attribute information about the first service may be configured to be output.

The service server of the second service requests information disclosure from the reservation candidate DB of the service reservation server 230-2 being a following service, based on the user answer acquired from the guidance promotion server 100 (S305). Further, for supplementary description, the first service is described as a starting service and the second service is described as a following service in the present disclosure, but an inquiry order of the service reservation server 230 is not unique.

The service reservation server 230-2 outputs, to the guidance promotion server 100, second service disclosure information and a following interaction clip (interactive video element) related to the second service disclosure information as information that can be shared with the first service, based on the disclosure request from the guidance promotion server 100 (S306).

The guidance promotion server 100 outputs the following interaction clip (interactive video element) in such a way that the following interaction clip can be viewed by the user device (S307).

When the guidance promotion server 100 acquires information about the interaction clip (video element) from a system of the guidance promotion server 100, the guidance promotion server 100 generates URL information and the like associated with the information, and outputs the URL information and the like to the user device. The user device can perform continuous reproduction in a form in which a following interaction clip (video element) is subsequently added during reproduction of an interaction clip (video), based on the URL information.

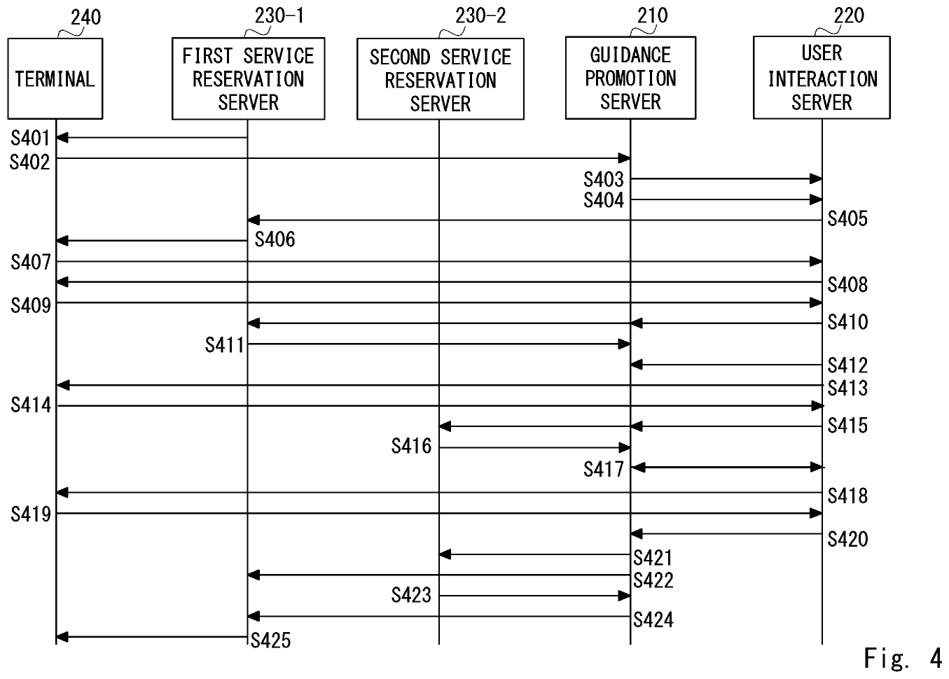

FIG. 4 is a sequence diagram illustrating one example of an operation of the reservation support system according to the second example embodiment.

In step S401, the service reservation server 230-1 receives a user behavior history request being transmitted from the terminal 240. For example, a client accesses a Web site of a first service site by using the terminal 240. On the Web site, an access history (behavior history) is acquired.

Next, in step S402, the user behavior history is output from the terminal 240 to the guidance promotion server 100 and the service reservation server 230-1.

Next, in step S403, the guidance promotion server 100 creates first inquiry information, and outputs the first inquiry information to the user interaction server 220.

Next, in step S404, the guidance promotion server 100 instructs the user interaction server 220 to create a recommended video from the behavior history of the user. For example, an API call is performed, and a video is created.

Next, in step S405, a personal video URL (PURL) is responded from the user interaction server 220 to the service reservation server 230-1.

Next, in step S406, the personal video URL is output from the service reservation server 230-1 to the terminal 240.

Next, in step S407, recommended information is displayed in the terminal 240. Then, an end user instructs the user interaction server 220 to reproduce a video.

Next, in step S408, the user interaction server 220 transmits a first video element constituting a personalized video to the terminal 240.

Next, in step S409, first response information is transmitted from the terminal 240 to the user interaction server 220. Specifically, a video created based on a following video element by the end user is automatically reproduced, and the end user selects (inputs) an answer for the video.

Next, in step S410, the first response information is transmitted from the user interaction server 220 to the guidance promotion server 100 and the service reservation server 230-1.

Next, in step S411, information about a first candidate group is shared with the guidance promotion server 100 from the user interaction server 220.

Next, in step S412, when a first candidate reservation can be temporarily made, the guidance promotion server 100 generates second inquiry information. Then, the second inquiry information is transmitted from the guidance promotion server 100 to the user interaction server 220.

Next, in step S413, the user interaction server 220 transmits a second video element constituting a personalized video to the terminal 240.

Next, in step S414, second response information is transmitted from the terminal 240 to the user interaction server 220. Specifically, a video created based on a following video element by the end user is automatically reproduced, and the end user selects (inputs) an answer for the video.

Next, in step S415, the second response information is transmitted from the user interaction server 220 to the guidance promotion server 100 and the service reservation server 230-2.

Next, in step S416, information about a second candidate group is shared with the second service reservation server 230-2 and the guidance promotion server 100. Then, in the guidance promotion server 100, extraction of an optimum candidate is performed from the information about the first candidate group shared in step S411 and the information about the second candidate group shared in this step.

Next, in step S417, an optimum candidate result is extracted in the guidance promotion server 100, and the optimum candidate result is shared with the guidance promotion server 100 and the user interaction server 220.

Next, in step S418, the user interaction server 220 transmits a video element by the optimum candidate result to the terminal 240.

Next, in step S419, when reservations of both of the first service reservation server 230-1 and the second service reservation server 230-2 can be temporarily made, the end user views a video (reservation final confirmation), and the end user confirms the reservation. Response information about the final confirmation of the reservation is transmitted from the terminal 240 to the user interaction server 220.

Next, in step S420, a candidate result is transmitted from the user interaction server 220 to the guidance promotion server 100.

Next, in step S421, candidate information about the second service is transmitted from the guidance promotion server 100 to the service reservation server 230-2.

Further, in step S422, candidate information about the first service is transmitted from the guidance promotion server 100 to the service reservation server 230-1.

Next, in step S423, a second service confirmation can be shared with the guidance promotion server 100 and the service reservation server 230-2.

Further, in step S424, work completion is notified from the guidance promotion server 100 to the service reservation server 230-1.

Next, in step S425, work completion is notified from the service reservation server 230-1 to the terminal 240.

By the sequence described above, a reservation is completed.

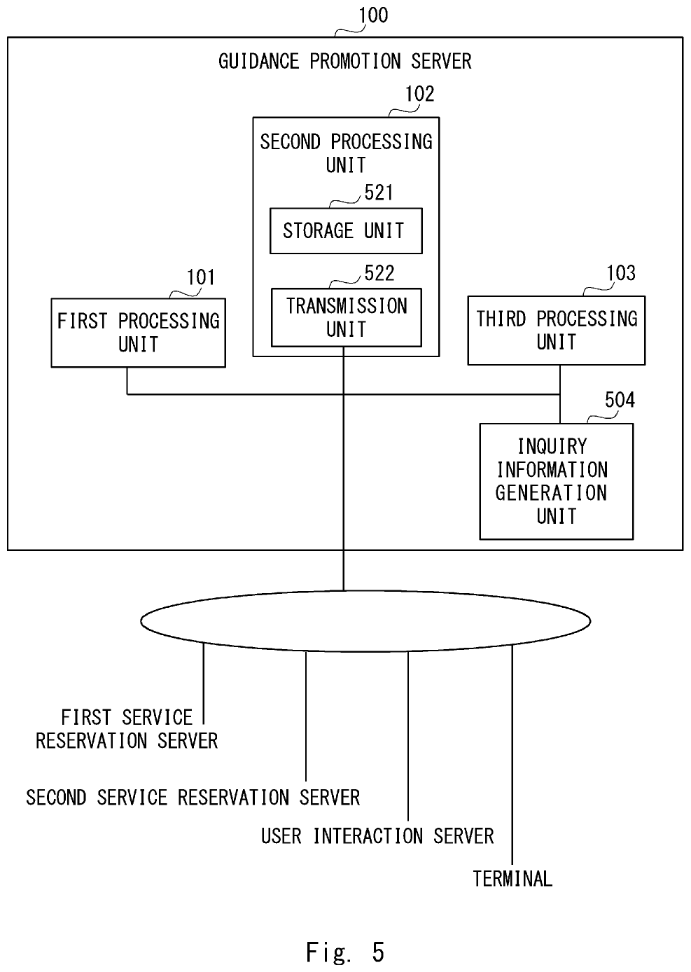

Next, a configuration of the guidance promotion server will be described. FIG. 5 is a block diagram illustrating a configuration of the guidance promotion server according to the second example embodiment. In FIG. 5, the guidance promotion server 100 includes a first processing unit 101, a second processing unit 102, a third processing unit 103, and an inquiry information generation unit 504. Further, the second processing unit 102 includes a storage unit 521 and a transmission unit 522. In FIG. 5, the same configuration as that in FIG. 1 is provided with same reference sign, and the description will be omitted.

The inquiry information generation unit 504 generates inquiry information about a reservation service including a content related to description of a service content and an inquiry content of the reservation service, and transmits the inquiry information to the user interaction server.

The storage unit 521 temporarily holds a candidate group of the first service answered by the first service reservation server.

The transmission unit 522 transmits, to the second service reservation server, a request that can be achieved by a candidate group answer of the first service among requests from the terminal.

In this way, the reservation support system according to the second example embodiment can reduce a withdrawal risk when reservations of a plurality of reservation services are continuously made.

As described above with reference to the example embodiments, according to the present disclosure, it is possible to provide guidance promotion server, a reservation support system, and a program that can reduce a withdrawal risk when reservations of a plurality of reservation services are continuously made.

Note that the present disclosure is not limited to the example embodiments described above, and may be appropriately modified without departing from the scope of the present disclosure. For example, a part or the whole of the functions of the user interaction server, the guidance promotion server, and the plurality of service reservation servers may be achieved on a cloud. Further, a part of the functions may be processed by artificial intelligence (AI).

Further, a service to be reserved may be three or more.

Further, the present disclosure is described as the example embodiments assumed to cooperate with a video provision system, but a system that provides GUI information for a user device may be a Web browser construction system in addition to the video provision system. In that case, when a user answer is transmitted to the guidance promotion server 100 via a Web site being viewed by a user, processing of changing a part of the Web image being drawn in response to that, and the like may be performed.

Each element described in the drawings as a functional block that performs various types of processing can be formed of a CPU, a memory, and another circuit in terms of hardware, and can be achieved by a program and the like loaded into the memory in terms of software. Therefore, it is understood by a person skilled in the art that the functional block can be achieved in various forms by only hardware, only software, or a combination thereof, which is not limited thereto.

Further, the program described above is stored by using various types of non-transitory computer-readable mediums, and can be supplied to a computer. The non-transitory computer-readable medium includes various types of tangible storage mediums. Examples of the non-transitory computer-readable medium include a magnetic recording medium (for example, a flexible disk, a magnetic tape, and a hard disk drive), a magneto-optical recording medium (for example, a magneto-optical disk), a CD-read only memory (CD-ROM), a CD-R, a CD-R/W, and a semiconductor memory (for example, a mask ROM, a programmable ROM (PROM), an erasable PROM (EPROM), a flash ROM, and a random access memory (RAM)). Further, the program may be supplied to the computer by various types of transitory computer-readable mediums. Examples of the transitory computer-readable medium include an electrical signal, an optical signal, and an electromagnetic wave. The transitory computer-readable medium may supply the program to the computer via a wired communication path such as an electric wire and an optical fiber or a wireless communication path.

### REFERENCE SIGNS LIST

100 GUIDANCE PROMOTION SERVER
101 FIRST PROCESSING UNIT
102 SECOND PROCESSING UNIT
103 THIRD PROCESSING UNIT
200 RESERVATION SUPPORT SYSTEM
220 USER INTERACTION SERVER
230 SERVICE RESERVATION SERVER
240 TERMINAL
504 INFORMATION GENERATION UNIT
521 STORAGE UNIT
522 TRANSMISSION UNIT

What is claimed is:

1. A guidance promotion server comprising:
at least one memory configured to store a command; and
at least one processor configured to execute the command, wherein the at least one processor
receives a request from a terminal, and transmits the request to a first service reservation server,
temporarily holds a candidate group of a first service being answered by the first service reservation server, based on the request from the terminal, and transmits a part of information constituting the candidate group of the first service to a second service reservation server, and
receives a candidate group answer of a second service from the second service reservation server, based on the information, and transmits, to a user interaction server, a narrowing result from a candidate group of the first service being narrowed from the temporarily held candidate group answer of the first service, based on the candidate group answer of the second service, and the candidate group answer of the second service.

2. The guidance promotion server according to claim 1, wherein the at least one processor generates inquiry information about a reservation service including a content related to description of a service content and an inquiry content of the reservation service, and transmits the inquiry information to the user interaction server.

3. The guidance promotion server according to claim 1, wherein the at least one processor further includes
a storage unit configured to temporarily hold a candidate group of the first service being answered by the first service reservation server, and
a transmission unit configured to transmit, to the second service reservation server, a request that can be achieved by a candidate group answer of the first service among requests from the terminal.

4. A reservation support system comprising:
a user interaction server; a guidance promotion server; and a plurality of service reservation servers, wherein
a first service reservation server receives a request from a terminal via the user interaction server and the guidance promotion server,
the first service reservation server answers a candidate group of a first service to the guidance promotion server,
the guidance promotion server temporarily holds the candidate group of the first service, and also transmits a part of information constituting the candidate group of the first service to a second service reservation server from the guidance promotion server,
a content related to description of a service content is provided from the second service reservation server to the user interaction server, and a candidate group answer of a second service is also transmitted from the second service reservation server to the guidance promotion server, based on the information,
the guidance promotion server transmits, to the user interaction server, a narrowing result from a candidate group of the first service being narrowed from the candidate group answer of the first service, based on the candidate group answer of the second service, and the candidate group answer of the second service, and
the user interaction server generates an interactive content related to candidate selection by combining the candidate group answer of the first service and the candidate group answer of the second service with a content from the second service reservation server, and transmits the generated content to the terminal.

5. A non-transitory computer-readable medium storing a program causing a computer to execute:
a first step of instructing a guidance promotion server to receive a request from a terminal, and transmit the request to a first service reservation server;
a second step of instructing the guidance promotion server to temporarily hold a candidate group of a first service being answered by the first service reservation server, based on the request from the terminal, and transmit a part of information constituting the candidate group of the first service to a second service reservation server; and
a third step of instructing the guidance promotion server to receive a candidate group answer of a second service from the second service reservation server, based on the information, and transmit, to a user interaction server, a narrowing result from a candidate group of the first service being narrowed from the temporarily held candidate group answer of the first service, based on the candidate group answer of the second service, and the candidate group answer of the second service.
